(19) United States
(12) Patent Application Publication
(10) Pub. No.: US 2026/0273943 A1
(43) Pub. Date: Sep. 17, 2026

(54) LIQUID DISCHARGE APPARATUS AND SUPPLY CONTROL METHOD

(71) Applicant: Satoshi KUNIOKA, Kanagawa (JP)

(72) Inventor: Satoshi KUNIOKA, Kanagawa (JP)

(21) Appl. No.: 19/534,778

(22) Filed: Feb. 10, 2026

(30) Foreign Application Priority Data
Mar. 12, 2025 (JP) 2025-039500

(51) Int. Cl. B41J 2/175; B41J 2/20; B41J 3/54

(52) U.S. Cl. CPC B41J 2/175; B41J 2/20; B41J 3/543

(57) ABSTRACT

A liquid discharge apparatus includes a liquid discharger, a liquid storage, a liquid supplier, and circuitry. The liquid discharger discharges a liquid. The liquid storage stores the liquid to be fed to the liquid discharger. The liquid supplier supplies two or more types of liquids to the liquid storage. The circuitry controls the liquid supplier to supply the two or more types of liquids to the liquid storage in multiple batches within a supply period to store the liquid including the two or more types of liquids at a predetermined mixing ratio in the liquid storage, and changes a number of the multiple batches according to a miscibility of the two or more types of liquids.

### CROSS-REFERENCE TO RELATED APPLICATION

This patent application is based on and claims priority pursuant to 35 U.S.C. § 119 (a) to Japanese Patent Application No. 2025-039500, filed on Mar. 12, 2025, in the Japan Patent Office, the entire disclosure of which is hereby incorporated by reference herein.

### BACKGROUND

### Technical Field

The present disclosure relates to a liquid discharge apparatus and a supply control method.

### Related Art

In the related art, a liquid discharge apparatus discharges a liquid from a liquid discharger onto a discharge target medium.

### SUMMARY

The present disclosure described herein provides an improved liquid discharge apparatus including a liquid discharger, a liquid storage, a liquid supplier, and a circuitry. The liquid discharger discharges a liquid. The liquid storage stores the liquid to be fed to the liquid discharger. The liquid supplier supplies two or more types of liquids to the liquid storage. The circuitry controls the liquid supplier to supply the two or more types of liquids to the liquid storage in multiple batches within a supply period to store the liquid including the two or more types of liquids at a predetermined mixing ratio in the liquid storage, and changes a number of the multiple batches according to a miscibility of the two or more types of liquids.

Further, the present disclosure described herein provides an improved a supply control method. The supply control method includes discharging a liquid; storing the liquid to be discharged; supplying two or more types of liquids; controlling the supplying the two or more types of liquids in multiple batches within a supply period to store the liquid including the two or more types of liquids at a predetermined mixing ratio; and changing a number of the multiple batches according to a miscibility of the two or more types of liquids.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating an overall configuration of a coating apparatus;

FIG. 2 is a diagram illustrating a configuration of a head of the coating apparatus of FIG. 1;

FIG. 3 is a cross-sectional view of the head taken along a plane S1 in FIG. 2;

FIG. 4 is a diagram illustrating a configuration of a supply unit of the coating apparatus of FIG. 1;

FIG. 5 is a diagram illustrating the movement (scanning) of the head of the coating apparatus of FIG. 1;

FIG. 6 is a block diagram of a control system of the coating apparatus of FIG. 1;

FIG. 7 is a functional block diagram of a controller of the coating apparatus of FIG. 1;

FIG. 8 is a flowchart of control of a supply operation by a supply unit of the coating apparatus of FIG. 1;

FIG. 9 is a diagram illustrating a diffusion supply unit that diffuses a first liquid and a second liquid and supplies the first liquid and the second liquid into a sub tank;

FIG. 10 is a diagram illustrating a stirring unit that stirs a mixed liquid fed out from a sub tank before the mixed liquid is fed to a head; and

FIG. 11 is a diagram illustrating a static mixer that mixes a mixed liquid fed out from a sub tank before the mixed liquid is fed to a head.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A description is given below of a liquid discharge apparatus. Embodiments described below are some examples, and the present disclosure is not limited to the embodiments described below. For example, the dimensions, materials, shapes of components described in the following embodiments, and relative arrangements thereof are not intended to limit the scope of the present disclosure thereto unless otherwise specified, and are merely examples for description. In the following description, like names and like reference signs denote like or equivalent components, and a detailed description thereof may be omitted as appropriate.

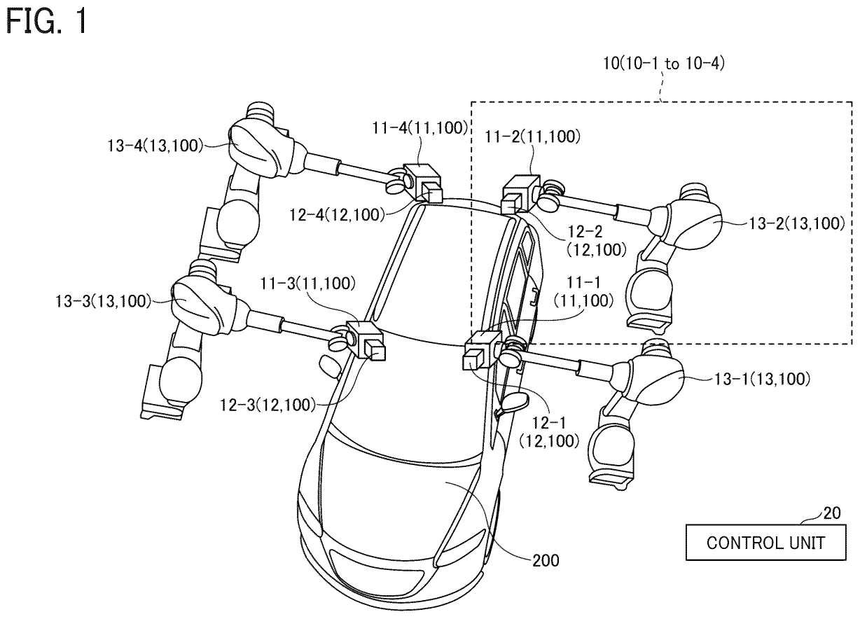

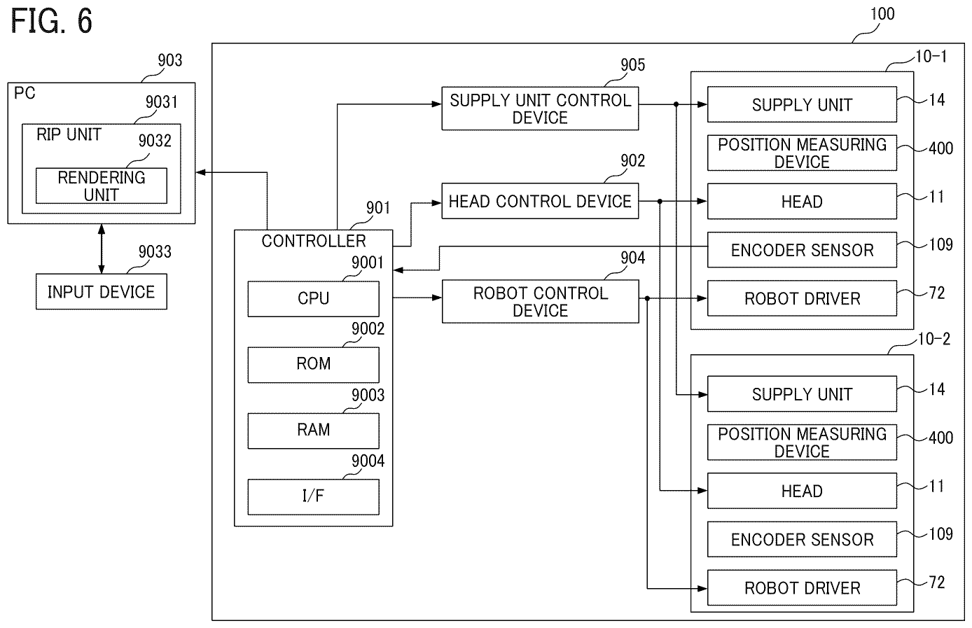

FIG. 1 is a schematic diagram illustrating an overall configuration of a coating apparatus 100 as a liquid discharge head. The coating apparatus 100 includes a coating unit 10 that discharges liquid to a vehicle 200 (automobile) as a discharge target medium to coat an exterior of the vehicle 200 and a control unit 20 that controls the coating unit 10. The coating apparatus 100 includes four coating units 10 (10-1 to 10-4) arranged around the vehicle 200 positioned at a predetermined coating position. Each of the coating units 10 has substantially the same configuration and includes a liquid discharge head 11 as a liquid discharger, a detector 12, a robot arm 13, and a supply unit 14 (see FIG. 6, i.e., a liquid supplier). In the following description, the liquid discharge head 11 may be referred to simply as a head 11.

In the following description, the discharge target medium is the exterior (body) of the vehicle 200, but the discharge target medium may be the exterior of a moving body other than the vehicle such as an aircraft or a ship. The vehicle 200 includes an automobile, a truck, and a train.

Each of the heads 11 (11-1 to 11-4) has a nozzle face in which multiple nozzles are formed, and is attached to the tip of the robot arm 13. The head 11 discharges liquid from the multiple nozzles. The robot arm 13 serves as a movement mechanism that moves the head 11 relative to the vehicle 200. In FIG. 1, the robot arm 13 moves the head 11 along the surface of the body of the vehicle 200, which may be referred to as a scanning of the head 11, to move the head 11 relative to the vehicle 200. The head 11 applies the liquid discharged from the nozzles to the vehicle 200 while being moved by the robot arm 13.

Each of the detectors 12 (12-1 to 12-4) is attached to the tip of the robot arm 13. The detector 12 outputs data of feature points regarding three-dimensional positions of three or more feature points in the vehicle 200. The detector 12 may include a three-dimensional (3D) camera such as a stereo camera, a 3D sensor other than the stereo camera, or a laser displacement gauge.

In FIG. 1, the detector 12 includes a stereo camera. For example, the stereo camera measures the position and inclination in X and Y directions, detects a coating start position, and detects a coating target size. The stereo camera includes multiple cameras, and acquires a distance image of the vehicle 200 by triangulation based on a parallax between images captured by the multiple cameras. The stereo camera can output the distance image to the control unit 20 as the data of feature points. The detector 12 may include a laser displacement gauge. For example, the laser displacement gauge may measure a distance in a Z direction, detect the height of the roof of the vehicle 200, and detect the curvature of the vehicle 200.

Each of the robot arms 13 (13-1 to 13-4) includes links and joints. The robot arm 13 rotates or displaces the links and the joints to change the relative position and the relative inclination of the head 11 and the vehicle 200. Thus, the nozzle face of the head 11 faces the vehicle 200.

The supply unit 14 supplies liquid to be discharged to the vehicle 200 to each of the four heads 11. Details of the supply unit 14 are described later.

The control unit 20 drives the robot arms 13 holding the respective four heads 11 based on shape data of the vehicle 200 and the data of feature points regarding the three-dimensional positions of the three or more feature points output from the corresponding four detectors 12. The coating apparatus 100 applies the liquid discharged from the four heads 11 to the vehicle 200 to coat the vehicle 200 with the liquid.

In the coating apparatus 100, the vehicle 200 is conveyed to the coating position, and the head 11 is moved by the robot arm 13 relative to the vehicle 200 not in motion to coat the vehicle 200. The vehicle 200 that has been coated is conveyed from the coating position to the outside, and the next vehicle 200 is conveyed to the coating position.

The coating apparatus 100 may include a maintenance unit in addition to the configuration illustrated in FIG. 1. The maintenance unit removes thickened liquid and foreign substances adhering to the nozzle face of the head 11 or inside the head 11. With such a configuration, abnormal discharge such as non-discharge, oblique discharge, and discharge speed fluctuation in the head 11 can be prevented, and the discharge state of the head 11 can be maintained in a normal condition.

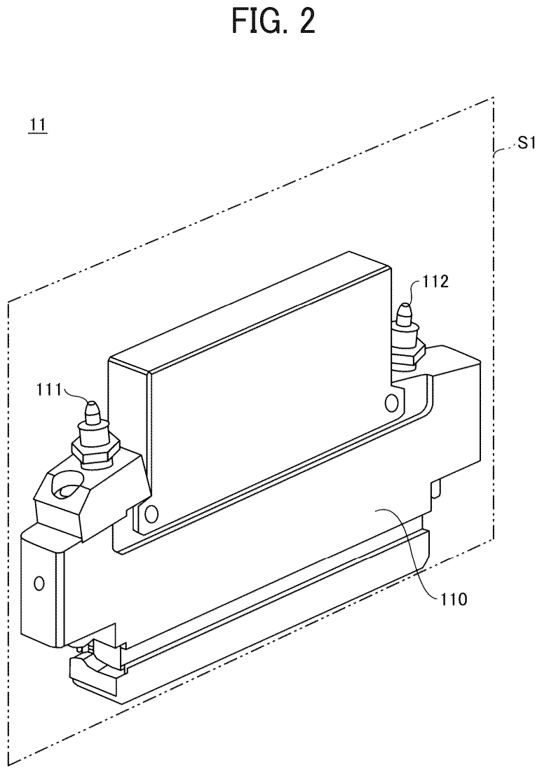

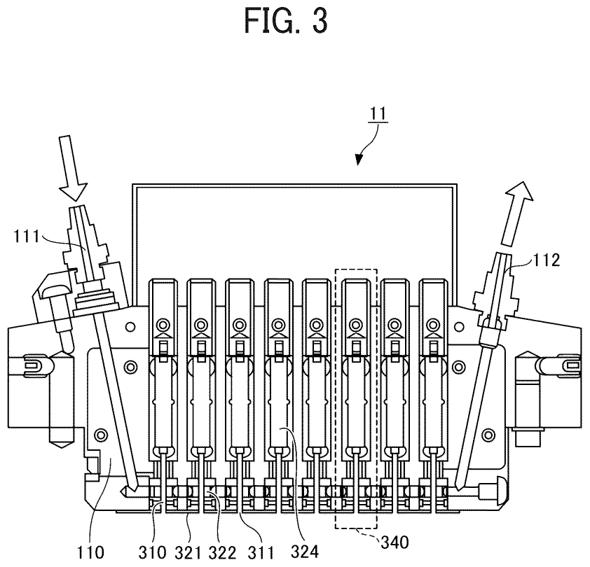

The configuration of the head 11 of the coating apparatus 100 will be described below with reference to FIGS. 2 and 3. FIG. 2 is a diagram illustrating the configuration of the head 11. FIG. 3 is a cross-sectional view of the head 11 taken along a plane S1 in FIG. 2. In FIGS. 2 and 3, the head 11 includes a supply port 111, a collection port 112, and discharge modules 340.

The supply port 111 is connected to the supply unit 14 and serves as an inlet through which the liquid is supplied from the supply unit 14 to the discharge modules 340. The collection port 112 is an outlet of the liquid. The liquid, which has not been discharged from a nozzle 311 when a valve of the nozzle 311 is opened, is drained to the outside through the collection port 112. The nozzle 311 is described in detail later.

The discharge module 340 includes a housing 110, a nozzle plate 321 having the nozzle 311, a channel 322 of the liquid, a valve 310, and a piezoelectric element 324.

The nozzle plate 321 is bonded to the housing 110. The liquid supplied from the supply port 111 is discharged from the nozzle 311 of the nozzle plate 321. The channel 322 is shared with the multiple discharge modules 340 (eight discharge modules in FIG. 2) in the housing 110.

The valve 310 is a needle-shaped valve body that is driven by the piezoelectric element 324. The valve 310 reciprocally moves in a liquid discharge direction in the housing 110 to open and close the nozzle 311. In the head 11, the pressurized liquid is supplied from the supply port 111 through the channel 322 with a valve of the collection port 112 closed. When the valve 310 closes the nozzle 311, the liquid is not discharged from the nozzle 311. When the piezoelectric element 324 is driven to move the valve 310 upward, the valve 310 opens the nozzle 311, and the liquid is discharged from the nozzle 311.

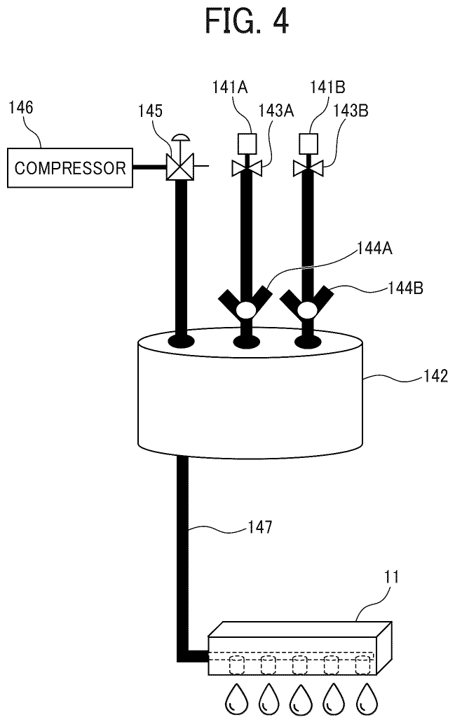

FIG. 4 is a diagram illustrating the configuration of the supply unit 14 of the coating apparatus 100.

In FIG. 4, the supply unit 14 (i.e., the liquid supplier) mixes two types of liquids (fluids) and supplies the mixed liquid to the head 11. The supply unit 14 includes a first main tank 141A that stores a first liquid, a second main tank 141B that stores a second liquid, and a sub tank 142 as a liquid storage that stores a liquid (mixed liquid) to be discharged from the head 11.

The sub tank 142 is connected to the first main tank 141A via a first valve 143A. The sub tank 142 is connected to the second main tank 141B via a second valve 143B. Check valves 144A and 144B are disposed in channels between the sub tank 142 and the first and second valves 143A and 143B, respectively. The sub tank 142 is selectively connected to a compressor 146 or outside air via a three-way valve 145. The sub tank 142 is also connected to a supply channel 147 communicating with the supply port 111 of the head 11.

When the first liquid in the first main tank 141A is supplied to the sub tank 142, the first valve 143A is opened, the second valve 143B is closed, and the three-way valve 145 is connected to the outside air to open the sub tank 142 to the atmosphere. When the second liquid in the second main tank 141B is supplied to the sub tank 142, the second valve 143B is opened, the first valve 143A is closed, and the three-way valve 145 is connected to the outside air to open the sub tank 142 to the atmosphere.

On the other hand, when the liquid (mixed liquid) in the sub tank 142 is fed to the head 11, the first valve 143A and the second valve 143B are closed, and the three-way valve 145 is connected to the compressor 146 to pressurize the sub tank 142 with air. At this time, the check valves 144A and 144B prevent the air in the sub tank 142 from flowing back to the first valve 143A and the second valve 143B. Accordingly, the liquid (mixed liquid) pressurized in the sub tank 142 is supplied as pressurized liquid from the supply channel 147 to the supply port 111 of the head 11, and the coating apparatus 100 discharges the liquid from the nozzles of the head 11.

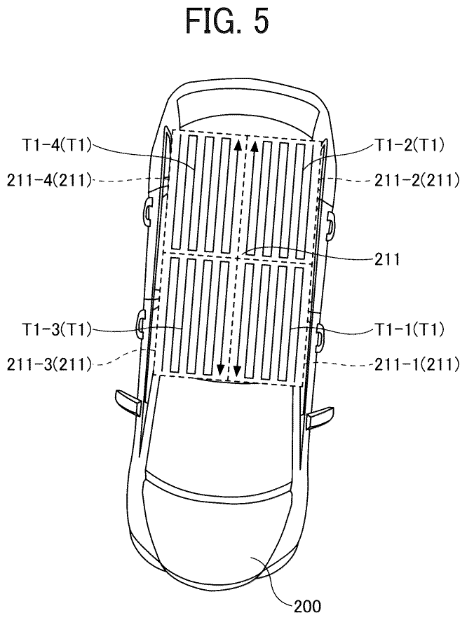

FIG. 5 is a diagram illustrating the movement (scanning) of the head 11 of the coating apparatus 100. In FIG. 5, the vehicle 200 is an automobile, and the coating areas 211 (211-1 to 211-4) are the roof of the automobile. The four robot arms 13 illustrated in FIG. 1 move the corresponding heads 11 relative to the vehicle 200 to coat the vehicle 200 with liquid in the respective coating areas 211. The coating areas 211 and movement paths T1 (T1-1 to T1-4) are different for the four heads 11, respectively. The movement path T1 may be referred to as a scanning route.

The robot arm 13-1 moves the head 11-1 relative to the vehicle 200 to coat the vehicle 200 with the liquid in the coating area 211-1. The head 11-1 is moved relative to the vehicle 200 along the movement path T1-1.

The robot arm 13-2 moves the head 11-2 relative to the vehicle 200 to coat the vehicle 200 with the liquid in the coating area 211-2. The head 11-2 is moved relative to the vehicle 200 along the movement path T1-2.

The robot arm 13-3 moves the head 11-3 relative to the vehicle 200 to coat the vehicle 200 with the liquid in the coating area 211-3. The head 11-3 is moved relative to the vehicle 200 along the movement path T1-3.

The robot arm 13-4 moves the head 11-4 relative to the vehicle 200 to coat the vehicle 200 with the liquid in the coating area 211-4. The head 11-4 is moved relative to the vehicle 200 along the movement path T1-4.

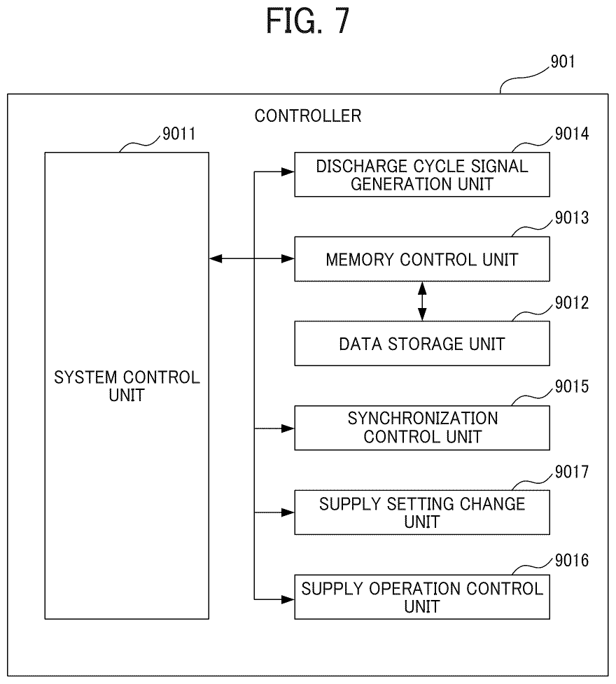

FIG. 6 is a block diagram of a control system of the coating apparatus 100. FIG. 7 is a functional block diagram of a controller 901 illustrated in FIG. 6. In FIG. 6, only two coating units 1-10 and 10-2 among the four coating units 10-1 to 10-4 are illustrated, and the illustrations of the remaining coating units 10-3 and 10-4 are omitted.

In FIG. 6, the coating system of the coating apparatus 100 includes the controller 901, a head control device 902, a robot control device 904, and a supply unit control device 905. The coating apparatus 100 is communicably connected to a personal computer (PC) 903 via a communication device.

The controller 901 as circuitry includes a central processing unit (CPU) 9001, a read-only memory (ROM) 9002, a random-access memory (RAM) 9003, and an interface (I/F) 9004. The controller 901, the head control device 902, and the robot control device 904 in FIGS. 6 and 7 correspond to the control unit 20 in FIG. 1.

The PC 903 includes a raster image processor (RIP) unit 9031 that performs image processing in accordance with a color profile and user settings, and a rendering unit 9032 that decomposes data of a coating portion of the vehicle 200 (e.g., a body of an automobile) into coating data (image data) for each scanning (e.g., each movement of the head 11 in the main scanning direction).

An input device 9033 is connected to the PC 903, for example, to set image data and coordinate data for coating the vehicle 200, to select a coating mode, to set a coating area (e.g., the coating start position and coating end position), to input an instruction for coating, and to determine the setting of mixed liquid to be discharged. The input device 9033 includes, for example, a keyboard, a mouse, and a touch panel to receive input from a user. The PC 903 acquires position data from a position measuring device 400 of each coating unit 10 and generates a coating route of the coating unit 10.

The CPU 9001 of the controller 901 is an arithmetic device that loads a program or data stored in, for example, the ROM 9002 into the RAM 9003 and executes processing to implement functions of the coating units 10-1 to 10-4. The CPU 9001 implements a function of a system control unit 9011 that controls the overall operation of the coating apparatus 100, using the image data for coating and commands received from the PC 903.

The CPU 9001 implements a function of a memory control unit 9013 that controls a data storage unit 9012, a function of a discharge cycle signal generation unit 9014 that generates a discharge cycle signal of liquid, and a function of a synchronization control unit 9015 that synchronizes the movements of the coating units 10-1 to 10-4 with an ink discharge operation. Further, the CPU 9001 implements a function of a supply operation control unit 9016 that controls the operation to supply liquid to the sub tank 142 in the supply unit 14, and a function of a supply setting change unit 9017 that changes the setting of the operation to supply liquid to the sub tank 142 in the supply unit 14. The CPU 9001 that functions as the memory control unit 9013 executes a program recorded in advance as stored data to implement the function of the controller 901.

The ROM 9002 is a nonvolatile memory that retains the program or data even after the power is turned off. The RAM 9003 is a volatile memory that is used as, for example, a work area for the CPU 9001. The ROM 9002 and the RAM 9003 implement a function of the data storage unit 9012 that stores, for example, the image data received from the PC 903 and data of the coating area (coating target size). For example, a hard disk drive (HDD) or a solid-state drive (SSD) may be used as a configuration having the function of the data storage unit 9012.

The I/F 9004 is an interface for inputting and outputting, for example, characters, numerals, and various instructions to and from various external devices. The I/F 9004 is an interface that allows the controller 901 to communicate with an external device such as the PC 903.

Each of the coating units 10-1 to 10-4 includes, for example, a multi-articulated robot as illustrated in FIG. 1. An encoder sensor 109 is attached to each joint of the robot arm 13 of each of the coating units 10-1 to 10-4. The encoder sensor 109 optically detects slits of an encoder attached to each joint, and outputs rotation amounts of each arm and the head 11. Then, three-dimensional position data of the head 11 is acquired based on the output signals (the rotation amounts of each arm and the head 11) of the encoder sensor 109.

The discharge cycle signal generation unit 9014 generates the discharge cycle signal of liquid based on an output signal of the encoder sensor 109 and the image data received from the PC 903. The synchronization control unit 9015 synchronizes the movements of the coating units 10-1 to 10-4 with the ink discharge operation based on the image data and the instruction for coating received from the PC 903.

The head control device 902 receives the discharge cycle signal from the discharge cycle signal generation unit 9014 of the controller 901 and controls the ink discharge operation in the head 11 based on the discharge cycle signal. The robot control device 904 receives a synchronization control signal from the synchronization control unit 9015 of the controller 901 and controls the driving of a robot driver 72 that drives joints of the robot arm 13 based on the synchronization control signal. The robot driver 72 is driven to move the head 11 of each of the coating units 10-1 to 10-4 to a desired position.

The supply unit control device 905 receives a supply command from the supply operation control unit 9016 of the controller 901 and controls the operation to supply liquid to the sub tank 142 in the supply unit 14 based on the supply command.

Although the head control device 902 and the robot control device 904 are shared by the coating units 10-1 to 10-4 as described above, the head control device 902 and the robot control device 904 may be provided for each of the coating units 10-1 to 10-4. The RIP unit 9031 and the rendering unit 9032 are installed in the PC 903 as described above, but may be installed in the system control unit 9011 of the controller 901.

A description is given below of a supply operation of the supply unit 14 that supplies liquid to the head 11. The supply unit 14 mixes two types of liquids, i.e., the first liquid and the second liquid, at a predetermined mixing ratio, and supplies the mixed liquid from the sub tank 142 to the head 11. In this supply, the mixed liquid to be fed to the head 11 is sufficiently mixed state. For example, the predetermined mixing ratio is determined in advance by a user.

If the first liquid and the second liquid are sequentially supplied (replenished) once each within a predetermined supply period (a supply operation period in which a desired supply amount of liquid is replenished into the sub tank 142), the mixed state of the first liquid and the second liquid in the sub tank 142 is likely to be insufficient at least at a stage immediately after the supply. In particular, when the first liquid and the second liquid are unlikely to be mixed with each other (i.e., poor miscibility), such as when at least one of the liquids has a high viscosity, the first liquid and the second liquid may be separated into a region of the first liquid and a region of the second liquid in the sub tank 142 at the stage immediately after the supply.

As described above, when the mixed state of the liquids in the sub tank 142 is insufficient at the stage immediately after the supply, the mixed state of the mixed liquid supplied from the sub tank 142 to the head 11 is likely to be insufficient. In other words, when the mixed state of the liquids in the sub tank 142 is insufficient at the stage immediately after the supply, the mixed state of the mixed liquid supplied to the head 11 is likely to be insufficient even if the liquids in the sub tank 142 are mixed by convection or other phenomena or by being stirred by a stirring unit (i.e., a stirrer). Alternatively, when the mixed state of the liquid in the sub tank 142 is insufficient at the stage immediately after the supply, the mixed state of the mixed liquid supplied to the head 11 is likely to be insufficient even if the liquid is mixed and stirred by, for example, a mixing unit or a mixer when the liquid is fed from the sub tank 142 to the head 11.

For this reason, the first liquid and the second liquid are sequentially supplied to the sub tank 142 multiple times (or in multiple batches) within a predetermined supply period (supply operation period). In other words, the supply amount of the first liquid and the supply amount of the second liquid to be replenished within the predetermined supply operation period are divided into multiple amounts, and the first liquid and the second liquid of each amount are alternately replenished. The multiple times (batched) of supply operations herein are supply operations within a supply period from when two or more types of liquid start to be supplied to the liquid storage (sub tank 142) to when the liquid in the sub tank 142 reaches a predetermined amount (e.g., the capacity of the sub tank 142 or the volume determined in advance by a user). According to such operations, even at the time immediately after the sub tank 142 is replenished, multiple regions formed of the first liquid and multiple regions formed of the second liquid are alternately positioned, and the regions of the different liquids can be adjacent to and overlap each other. As a result, even at the time immediately after the sub tank 142 is replenished, the first liquid and the second liquid can be dispersed to some extent, and thus the mixed state of the mixed liquid to be fed to the head 11 can be prevented from becoming insufficient.

The mixed state of the mixed liquid fed to the head 11 depends on the types of the first liquid and the second liquid mixed in the mixed liquid. For example, when these liquids are unlikely to be mixed with each other (i.e., poor miscibility), the mixed state of the mixed liquid to be fed to the head 11 is likely to be insufficient. Accordingly, when the first liquid and the second liquid are unlikely to be mixed with each other, it is effective to increase the number of times (supply batches or multiple batches) each of the first liquid and the second liquid is supplied (by the divided smaller amounts of the first liquid and the second liquid) within a predetermined supply operation period, and to create a state in which the first liquid and the second liquid are dispersed to some extent even at the time immediately after the sub tank 142 is replenished.

Another case will be described below. As described above, when the number of times (supply batches) of supply of the first liquid and the second liquid in a predetermined supply operation period is increased, the time (supply operation period) for the supply operation to replenish the sub tank 142 with the first liquid and the second liquid is increased. Accordingly, even when the first liquid and the second liquid are likely to be mixed with each other (i.e., good miscibility), if the supply operation is performed the same number of times (supply batches) as when the first liquid and the second liquid are unlikely to be mixed with each other, the time (supply operation period) for the supply operation becomes unnecessarily long.

For this reason, the setting of the number of times (supply batches) each of the first liquid and the second liquid is supplied within a predetermined supply operation period can be changed. Accordingly, for example, when the first liquid and the second liquid are unlikely to be mixed with each other (i.e., poor miscibility), the number of times (supply batches) of supply of each of the first liquid and the second liquid is increased to obtain a sufficient mixed state. When the first liquid and the second liquid are likely to be mixed with each other (i.e., good miscibility), the number of times (supply batches) of supply of each of the first liquid and the second liquid is decreased to prevent the supply operation period from becoming unnecessarily long. In other words, the controller 901 (supply setting change unit 9017) changes a number of the multiple batches according to a miscibility of two or more types of liquids (e.g., the first liquid and the second liquid).

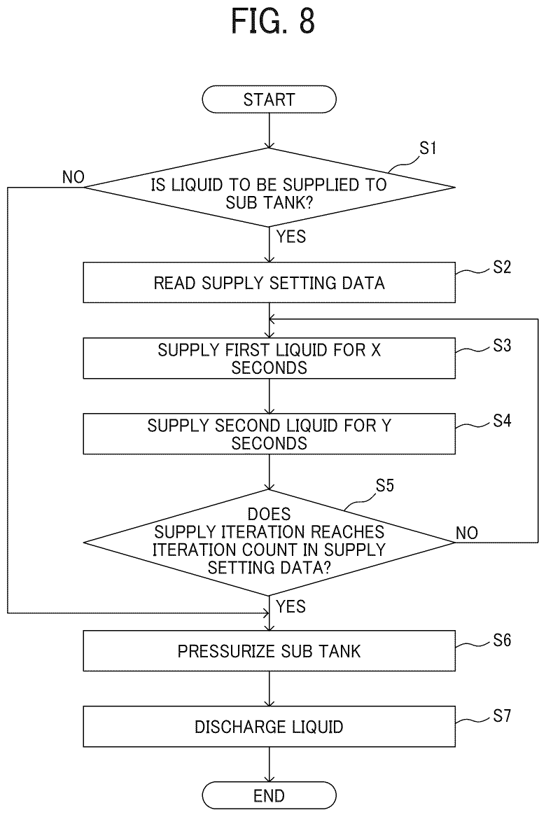

FIG. 8 is a flowchart of control of the supply operation by the supply unit 14. In step S1, when the timing for replenishing the sub tank 142 with the liquid in the supply unit 14 comes, in step S2, the supply operation control unit 9016 of the controller 901 reads supply setting data stored in the data storage unit 9012, and outputs the supply command according to the supply setting data to the supply unit control device 905. At this time, if the head 11 continues the liquid discharge operation, the liquid discharge operation of the head 11 is interrupted, and the head 11 is in a standby state.

The supply unit control device 905 that has received the supply command closes the second valve 143B and connects the three-way valve 145 to the outside air to open the sub tanks 142 to the atmosphere in order to supply the first liquid in the first main tank 141A to the sub tank 142. Then, in accordance with the received supply command, the first valve 143A is opened for X seconds, which is the supply operation period of the first liquid included in the supply setting data. Thus, in step S3, the first liquid in the first main tank 141A is supplied to the sub tank 142.

Subsequently, in order to supply the second liquid in the second main tank 141B to the sub tank 142, the supply unit control device 905 closes the first valve 143A and connects the three-way valve 145 to the outside air to open the sub tank 142 to the atmosphere. Then, in accordance with the received supply command, the second valve 143B is opened for Y seconds, which is the supply operation period of the second liquid included in the supply setting data. Thus, in step S4, the second liquid in the second main tank 141B is supplied to the sub tank 142.

In step S5, the supply unit control device 905 repeats a set of one supply operation for the first liquid and one supply operation for the second liquid until the supply iteration reaches an iteration count (the number of supply batches Z) included in the supply setting data, in accordance with the received supply command (No in step S5). Thus, the state in which the first liquid and the second liquid are dispersed to some extent can be created even at the time immediately after the sub tank 142 is replenished.

When the iteration of the supply operation of the first liquid and the second liquid reaches the iteration count (the number of supply batches Z) set by the supply setting data (Yes in step S5), in step S6, the supply unit control device 905 closes the first valve 143A and the second valve 143B, and connects the three-way valve 145 to the compressor 146 to pressurize the sub tanks 142 with air. Accordingly, the liquid discharge operation becomes ready, and the liquid (mixed liquid) pressurized in the sub tank 142 is supplied from the supply channel 147 to the supply port 111 of the head 11. Thus, in step S7, the liquid is discharged from the nozzles of the head 11.

The supply setting change unit 9017 of the controller 901 changes the setting of the number of supply batches (multiple batches) Z of each of the first liquid and the second liquid within a predetermined supply operation period. For example, the supply setting change unit 9017 receives the number of times specified by a user operation input from the input device 9033 connected to the PC 903, and rewrites the setting of the number of supply batches Z of the first liquid and the second liquid included in the supply setting data stored in the data storage unit 9012 to the received number of times specified by the user. Alternatively, when the number of supply batches Z of the first liquid and the second liquid is set for the first time, the supply setting change unit 9017 writes and sets the received number of times specified by the user as the number of supply batches Z of the first liquid and the second liquid in the supply setting data stored in the data storage unit 9012.

According to such operations, when the user uses the first liquid and the second liquid, which are unlikely to be mixed with each other, the user may input the number of supply batches Z increased according to the degree of difficulty in mixing from the input device 9033 to perform the liquid discharge operation (coating process) with the mixed liquid in a sufficient mixed state. Further, when the user uses the first liquid and the second liquid, which are likely to be mixed with each other, the user may input the number of supply batches Z reduced according to the degree of easiness of mixing from the input device 9033, so that the supply operation period can be shortened while obtaining a sufficient mixed state, and the standby time until the liquid discharge operation is started or restarted can be shortened. Table 1 below illustrates an example of the content of the supply setting data.

TABLE 1

| THE NUMBER OF | | |
|---|---|---|
| SUPPLY | TYPES OF | SUPPLY OPERATION |
| BATCHES (Z) | LIQUIDS | TIME (s) |
| 1 | FIRST LIQUID (X) | 1 |
| | SECOND LIQUID (Y) | 2 |
| 2 | FIRST LIQUID (X) | 0.5 |
| | SECOND LIQUID (Y) | 1 |
| 4 | FIRST LIQUID (X) | 0.25 |
| | SECOND LIQUID (Y) | 0.5 |

In the supply setting data of Table 1, the user can select and specify the number of supply batches Z from “once,” “twice,” and “four times.” At this time, as in the supply setting data illustrated in Table 1, the supply amount of each of the first liquid and the second liquid supplied by one supply operation is preferably reduced as the number of supply batches Z increases. According to such operations, even when the number of supply batches Z changes, the difference in the total supply amount (total amount) of the first liquid and the second liquid supplied within a predetermined supply operation period can be reduced. Accordingly, even when the number of supply batches Z changes, a situation in which the total amount of liquid supplied into the sub tank 142 exceeds the allowable amount of the sub tank 142 or the total amount of liquid supplied into the sub tank 142 is significantly insufficient can be avoided with simple control.

In particular, as in the supply setting data illustrated in Table 1, the total supply amount (total amount) of the first liquid and the second liquid supplied within a predetermined supply operation period is preferably constant even when the number of supply batches Z changes.

In the above description, the supply setting change unit 9017 changes the number of supply batches Z in accordance with, but not limited to, the number of times input (selected) by the user. For example, the supply setting change unit 9017 may determine the number of times in accordance with viscosity data of the first liquid and the second liquid to be used, and change the number of supply batches Z to the determined number of times. Specifically, for example, the supply setting change unit 9017 may store the viscosity data of various liquids in a database, determine the number of times based on the viscosity data corresponding to the liquid input (selected) by the user, and change the number of supply batches Z to the determined number of times.

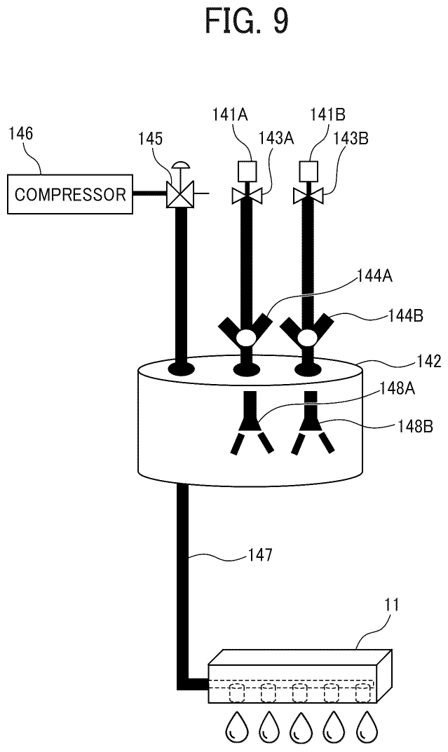

The supply unit 14 may include a diffusion supply unit that diffuses and supplies the first liquid and the second liquid into the sub tank 142. For example, spray nozzles 148A and 148B may be used as the diffusion supply units, as illustrated in FIG. 9. Specifically, the spray nozzles 148A and 148B as the diffusion supply units are disposed at a first inlet for taking the first liquid into the sub tank 142 and a second inlet for taking the second liquid into the sub tank 142, respectively. According to such a configuration, since each liquid is dispersed in the sub tank 142 at the time when each liquid is supplied into the sub tank 142, a situation in which each liquid is locally accumulated in a part of the sub tank 142 can be avoided. As a result, even at the time immediately after the sub tank 142 is replenished, the first liquid and the second liquid are likely to be dispersed.

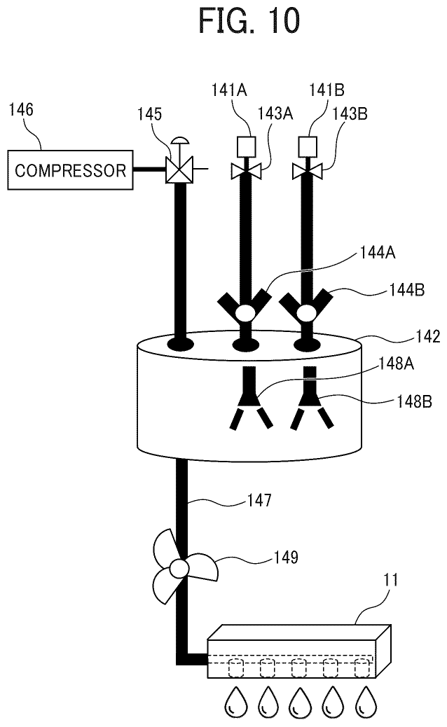

The supply unit 14 may include a stirring unit (stirrer) that stirs the mixed liquid fed out from the sub tank 142 before the mixed liquid is fed to the head 11. For example, a rotating propeller mechanism 149 may be used as the stirring unit, as illustrated in FIG. 10. Specifically, the rotating propeller mechanism 149 is disposed in the supply channel 147 connecting the sub tank 142 and the supply port 111 of the head 11. Accordingly, even when the mixed state of the mixed liquid is insufficient at the stage when the mixed liquid is fed out from the sub tank 142, the mixed liquid is stirred and mixed while passing through the rotating propeller mechanism 149, and thus a sufficient mixed state can be obtained at the stage when the mixed liquid is supplied to the head 11.

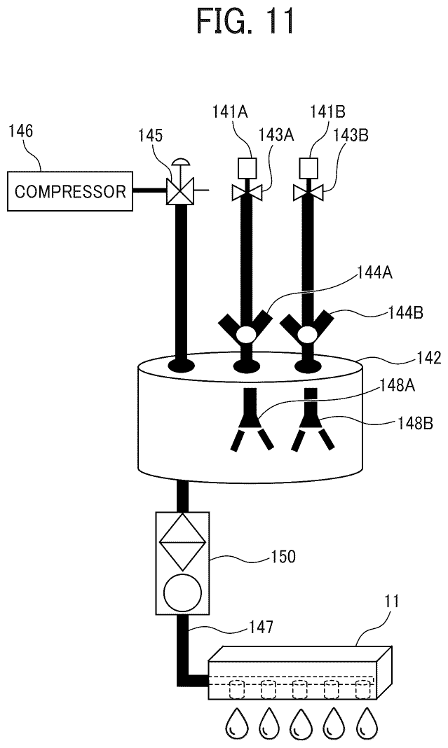

As illustrated in FIG. 11, the supply unit 14 may include a static mixer 150 that mixes the mixed liquid fed from the sub tank 142 before the mixed liquid is fed to the head 11. Specifically, the static mixer 150 is disposed in the supply channel 147 connecting the sub tank 142 and the supply port 111 of the head 11. Accordingly, even when the mixed state of the mixed liquid is insufficient at the stage when the mixed liquid is fed out from the sub tank 142, the mixed liquid is mixed while passing through the static mixer 150, and thus a sufficient mixed state can be obtained at the stage when the mixed liquid is supplied to the head 11.

In the above description, the head 11 discharges the mixed liquid obtained by mixing two types of liquids in the sub tank 142. Alternatively, the head 11 may discharge a mixed liquid obtained by mixing three or more types of liquids in the sub tank 142. In the above description, all the fluids to be supplied to the sub tank 142 are liquid. Alternatively, at least one of the fluids may be powder or particles.

The embodiments described above are just examples, and the various aspects of the present disclosure attain respective effects as follows.

### Aspect 1

According to Aspect 1, a liquid discharge apparatus (e.g., the coating apparatus 100) includes a liquid discharge unit (e.g., the head 11, which may be referred to as a liquid discharger), a storage unit (e.g., the sub tank 142, which may be referred to as a liquid storage) that stores a liquid (e.g., the mixed liquid) to be fed to the liquid discharge unit, a liquid supply unit (e.g., the first valve 143A and the second valve 143B, which may be referred to as a liquid supplier) that supplies the liquid to the storage unit, a controller (e.g., the supply operation control unit 9016 and the supply unit control device 905), and a setting change unit (e.g., the supply setting change unit 9017). The controller controls a supply operation of the liquid supply unit so that a liquid containing two or more types of liquids (e.g., a first liquid and a second liquid) at a predetermined mixing ratio is stored in the storage unit. The setting change unit changes a setting of supply iteration count (e.g., the number of supply batches) of each of the two or more types of liquids within a supply period (e.g., a predetermined supply operation period) from when the two or more types of liquids start to be supplied to the storage unit to when the liquid stored in the storage unit reaches a predetermined amount. The controller controls the supply operation of the liquid supply unit so that each of the two or more types of liquids is supplied to the storage unit in multiple batches within the supply period according to the setting by the setting change unit.

In other words, a liquid discharge apparatus includes a liquid discharger, a liquid storage, a liquid supplier, and circuitry. The liquid discharger discharges a liquid. The liquid storage stores the liquid to be fed to the liquid discharger. The liquid supplier supplies two or more types of liquids to the liquid storage. The circuitry controls the liquid supplier to supply the two or more types of liquids to the liquid storage in multiple batches within a supply period to store the liquid including the two or more types of liquids at a predetermined mixing ratio in the liquid storage, and changes a number of the multiple batches according to a miscibility of the two or more types of liquids.

In an apparatus that stores a liquid in which two or more types of liquids are mixed at a predetermined mixing ratio in a storage unit and discharges the liquid, which is fed from the storage unit to a liquid discharge unit, to a discharge target medium, the two or more types of liquids are mixed in a sufficiently mixed state in the liquid fed to the liquid discharge unit. At this time, when the two or more types of liquids are sequentially supplied once each within a predetermined supply period, the two or more types of liquids are divided into respective regions at a time immediately after the supply into the storage unit is completed. In such a state, the mixed state of the liquid fed to the liquid discharge unit is likely to be insufficient.

In this aspect, the liquid supply unit supplies the two or more types of liquids to the storage unit in multiple batches within a supply period from when the two or more types of liquids start to be supplied to the storage unit to when the liquid stored in the storage unit reaches a predetermined amount. Accordingly, at the time immediately after the supply into the storage unit is completed, the two or more types of liquids are respectively divided into multiple regions, and the regions of the different liquids can be adjacent to and overlap each other. As a result, since the two or more types of liquids are dispersed to some extent at a time immediately after the supply into the storage unit is completed, the mixed state of the liquid fed to the liquid discharge unit can be prevented from becoming insufficient.

The mixed state of the liquid fed to the liquid discharge unit depends on the types of two or more types of liquids mixed in the liquid. For example, when the two or more types of liquids are unlikely to be mixed with each other, such as when a liquid having a high viscosity is included in the two or more types of liquids, the mixed state of the liquid fed to the liquid discharge unit is likely to be insufficient. Accordingly, when the two or more types of liquids are unlikely to be mixed with each other, it is effective to increase the number of supply batches of each of the two or more types of liquids within a predetermined supply period to create a state in which the two or more types of liquids are dispersed to some extent at a time immediately after the supply into the storage unit is completed.

In this aspect, the setting change unit changes the setting of the number of supply batches of each of the two or more types of liquids within a predetermined supply period, and the supply operation of the liquid supply unit is controlled according to the setting by the setting change unit. According to this aspect, for example, when two or more types of liquids are unlikely to be mixed with each other, the number of supply batches of each of the two or more types of liquids is increased to obtain a sufficient mixed state.

### Aspect 2

According to Aspect 2, in the liquid discharge apparatus of Aspect 1, the setting change unit changes the setting so as to reduce each supply amount of the two or more types of liquids supplied at one time as the number of supply batches of each of the two or more types of liquids increases.

In other words, the circuitry decreases a supply amount of each of the two or more types of liquids in one of the multiple batches with an increase in the number of the multiple batches.

According to this aspect, even when the setting of the number of supply batches of each of the two or more types of liquids is changed, a difference in the total supply amount of each of the two types of liquids supplied within a predetermined supply period can be reduced. Accordingly, even when the setting of the number of supply batches of each of the two or more types of liquids is changed, a situation in which the total supply amount of liquid supplied into the storage unit exceeds the allowable amount of the storage unit or the total supply amount of liquid supplied into the storage unit is significantly insufficient can be easily avoided.

### Aspect 3

According to Aspect 3, in the liquid discharge apparatus of Aspect 2, the setting change unit changes the setting of the supply amount so that the total supply amount of each of the two or more liquids supplied during the supply period is constant.

In other words, the circuitry keeps a total supply amount of the two or more types of liquids within the supply period constant, in the number of the multiple batches changed.

According to this aspect, even when the setting of the number of supply batches of each of the two or more types of liquids is changed, a situation in which the total supply amount of liquid supplied into the storage unit exceeds the allowable amount of the storage unit or the total supply amount of liquid supplied into the storage unit is significantly insufficient can be more easily avoided.

### Aspect 4

According to Aspect 4, in the liquid discharge apparatus of any one of Aspects 1 to 3, the setting change unit changes the setting of the number of supply batches of each liquid in accordance with the viscosity of the liquid.

In other words, the circuitry changes the number of the multiple batches according to a viscosity of each of the two or more types of liquids.

### Aspect 5

According to Aspect 5, in the liquid discharge apparatus of any one of Aspects 1 to 4, the liquid supply unit includes a diffusion supplier (e.g., the spray nozzles 148A and 148B) that diffuses and supplies the two or more types of liquids into the storage unit.

In other words, the liquid supplier includes a diffusion supplier to diffuse and supply the two or more types of liquids into the liquid storage.

According to this aspect, even at the time immediately after the supply into the storage unit, a state in which the two or more types of liquids are respectively dispersed can be easily created, and thus a state in which the two or more types of liquids are more dispersed can be created.

### Aspect 6

According to Aspect 6, the liquid discharge apparatus of any one of Aspects 1 to 5, further includes a stirring unit (e.g., the rotating propeller mechanism 149) to stir the liquid fed from the storage unit before supplying the liquid to the liquid discharge unit.

In other words, the liquid discharge apparatus according to any one of Aspects 1 to 5, further includes a stirrer disposed between the liquid storage and the liquid discharger, to stir the liquid, fed from the liquid storage, to be supplied to the liquid discharger.

According to this aspect, even when the mixed state of the liquid is insufficient at the stage when the mixed liquid is fed out from the storage unit, the liquid is stirred by the stirring unit, and thus, a sufficient mixed state can be obtained at the stage when the mixed liquid is supplied to the liquid discharge unit.

### Aspect 7

According to Aspect 7, the liquid discharge apparatus of any one of Aspects 1 to 6, further includes a static mixer (e.g., the static mixer 150) to mix the liquid fed from the storage unit before supplying the liquid to the liquid discharge unit.

In other words, the liquid discharge apparatus according to any one of Aspects 1 to 6, further includes a static mixer disposed between the liquid storage and the liquid discharger, to mix the liquid, fed from the liquid storage, to be supplied to the liquid discharger.

According to this aspect, even when the mixed state of the liquid is insufficient at the stage when the mixed liquid is fed out from the storage unit, the liquid is mixed by the static mixer, and thus, a sufficient mixed state can be obtained at the stage when the mixed liquid is supplied to the liquid discharge unit.

### Aspect 8

According to Aspect 8, in a control method for controlling a supply operation in a liquid supply unit that supplies a liquid containing two or more types of liquids at a predetermined mixing ratio to a storage unit that stores a liquid to be fed to a liquid discharge unit of a liquid discharge apparatus, the control method includes changing a setting of a number of supply batches of each of the two or more types of liquids within a supply period from when the two or more types of liquids start to be supplied to the storage unit to when the liquid stored in the storage unit reaches a predetermined amount, and controlling the supply operation such that each of the two or more types of liquids is supplied to the storage unit in multiple batches within the supply period in accordance with the setting changed in the changing the setting.

In other words, a supply control method includes discharging a liquid; storing the liquid to be discharged; supplying two or more types of liquids; controlling the supplying the two or more types of liquids in multiple batches within a supply period to store the liquid including the two or more types of liquids at a predetermined mixing ratio; and changing a number of the multiple batches according to a miscibility of the two or more types of liquids.

According to this aspect, the liquid in a sufficiently mixed state can be supplied to the storage unit of the liquid discharge apparatus that discharges the liquid containing the two or more types of liquids mixed at a predetermined mixing ratio.

As described above, according to one aspect of the present disclosure, in an apparatus that discharges a liquid containing two or more types of liquids mixed at a predetermined mixing ratio, a sufficiently mixed state of the liquids can be obtained.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. A liquid discharge apparatus comprising:
a liquid discharger to discharge a liquid;
a liquid storage to store the liquid to be fed to the liquid discharger;
a liquid supplier to supply two or more types of liquids to the liquid storage;
circuitry configured to:
control the liquid supplier to supply the two or more types of liquids to the liquid storage in multiple batches within a supply period,
to store the liquid including the two or more types of liquids at a predetermined mixing ratio in the liquid storage; and
change a number of the multiple batches according to a miscibility of the two or more types of liquids.

2. The liquid discharge apparatus according to claim 1,
wherein the circuitry is further configured to:
decrease a supply amount of each of the two or more types of liquids in one of the multiple batches with an increase in the number of the multiple batches.

3. The liquid discharge apparatus according to claim 2,
wherein the circuitry is further configured to:
keep a total supply amount of the two or more types of liquids within the supply period constant,
in the number of the multiple batches changed.

4. The liquid discharge apparatus according to claim 1,
wherein the circuitry is further configured to:
change the number of the multiple batches according to a viscosity of each of the two or more types of liquids.

5. The liquid discharge apparatus according to claim 1,
wherein the liquid supplier includes:
a diffusion supplier to diffuse and supply the two or more types of liquids into the liquid storage.

6. The liquid discharge apparatus according to claim 1, further comprising:
a stirrer disposed between the liquid storage and the liquid discharger,
to stir the liquid, fed from the liquid storage, to be supplied to the liquid discharger.

7. The liquid discharge apparatus according to claim 1, further comprising:
a static mixer disposed between the liquid storage and the liquid discharger,
to mix the liquid, fed from the liquid storage, to be supplied to the liquid discharger.

8. A supply control method comprising:
discharging a liquid;
storing the liquid to be discharged;
supplying two or more types of liquids;
controlling the supplying the two or more types of liquids in multiple batches within a supply period to store the liquid including the two or more types of liquids at a predetermined mixing ratio; and
changing a number of the multiple batches according to a miscibility of the two or more types of liquids.
